(19) United States
(12) Patent Application Publication
(10) Pub. No.: US 2009/0157245 A1
(43) Pub. Date: Jun. 18, 2009

(54) Method for limiting motor torque in hybrid electric vehicle

(75) Inventors: Sang Hyeon Moon, Gyeonggi-do (KR); Ji Hoon Jang, Gyeonggi-do (KR); Hyung Bin Ihm, Seoul (KR); Jin Hwan Jung, Gyeonggi-do (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/215,787

(22) Filed: Jun. 30, 2008

(30) Foreign Application Priority Data
Dec. 13, 2007 (KR) 10-2007-0129660

(51) Int. Cl. B60W 10/08; B60L 15/20; B60W 20/00

(52) U.S. Cl. 701/22; 180/65.285

(57) ABSTRACT

The present invention provides a method for limiting motor torque in a hybrid electric vehicle, which limits the output of motor torque that causes a reverse rotation of an engine in a soft hybrid electric vehicle in which a motor and the engine are directly connected to each other, thus preventing the engine from being damaged.

### CROSS-REFERENCE TO RELATED APPLICATION

This application claims under 35 U.S.C. §119(a) the benefit of Korean Patent Application No. 10-2007-0129660 filed Dec. 13, 2007, the entire contents of which are incorporated herein by reference.

### BACKGROUND

(a) Technical Field

The present invention relates to a method for limiting torque of a motor in a hybrid electric vehicle. More particular, the present invention relates to a method for limiting motor torque in a hybrid electric vehicle, in which output of motor torque that can cause a reverse rotation of an engine in a soft hybrid electric vehicle is limited and damage to the engine that can be caused by the reverse rotation is thus prevented.

(b) Background Art

A hybrid vehicle, in the broad sense, means a vehicle driven by efficiently combining at least two different types of power source. However, in most cases, the hybrid vehicle is driven by an engine and an electric motor, and such a hybrid vehicle is referred to as a hybrid electric vehicle (HEV).

To meet the demands of today's society for improved fuel efficiency and the development of a more environmentally friendly product, research into hybrid electric vehicles is being actively conducted.

In the hybrid vehicle, the electric motor for driving the vehicle is driven by electric power from a high voltage battery mounted in the vehicle. In addition to the object of driving the vehicle, the motor converts kinetic energy of the vehicle into electric energy to charge a battery during regenerative braking (energy regeneration).

That is, the electric motor uses electric energy stored in the battery to drive the vehicle and uses a portion of the kinetic energy during the running of the vehicle to generate electricity and charge the battery with the generated electric energy, thus realizing the reduction in kinetic energy (running speed) and the generation of electric energy at the same time.

Meanwhile, in a case of a soft hybrid electric vehicle as shown in FIG. 1, an engine 1 and an electric motor 2 are directly connected to each other, and the engine power and the motor power are combined and transmitted to a drive shaft through a transmission 3.

In the above structure, a controller 5 (generally referred to as a motor controller) controls the operation of the motor 2 driven by electric power of a battery 6.

Since the above-described soft hybrid electric vehicle has no clutch between the engine 1 and the motor 2, an independent output of the engine 1 is possible; however, an independent output of the motor 2 is impossible.

Accordingly, when the engine is rotated, the motor is also rotated even without torque output from the motor and, on the contrary, when the motor is rotated by outputting a torque, the engine is rotated together with the motor.

However, the above-described soft hybrid electric vehicle has a problem in that when a reverse rotation of the engine occurs by a reverse torque of the motor, the engine may be damaged, which needs to be solved.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. The present invention is directed to a method for limiting a motor torque in a hybrid electric vehicle, which limits a motor torque output that can cause a reverse rotation of an engine in a soft hybrid electric vehicle, thus preventing the engine from being damaged.

In one aspect, the present invention provides a method for limiting motor torque in a hybrid electric vehicle, the method comprising: determining whether a current mode is a motoring mode or a generating mode; comparing a current motor speed with a regenerative torque limit starting speed predetermined according to an engine idling speed of the vehicle, if the current mode is a generating mode; and limiting motor torque output using a torque command value calculated based on a maximum regenerative torque, the regenerative torque limit starting speed and the motor speed, if the motor speed exceeds 0 and does not exceed the regenerative torque limit starting speed in the generating mode.

Preferably, the method further comprises: comparing the current motor speed with a predetermined motoring torque output limiting speed, if the current mode is a motoring mode; and limiting the motor torque output using a torque command value of 0, if the motor speed does not exceed the motoring torque output limiting speed in the motoring mode.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a configuration diagram showing a drive system of a soft hybrid electric vehicle;

FIG. 2 is a diagram showing a torque-speed characteristic of motor torque control according to the present invention; and

FIG. 3 is a flowchart illustrating a method for controlling motor torque according to the present invention.

Reference numerals set forth in the Drawings includes reference to the following elements as further discussed below:

| | |
|---|---|
| 1: engine | 2: motor |
| 3: transmission | 5: motor controller |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

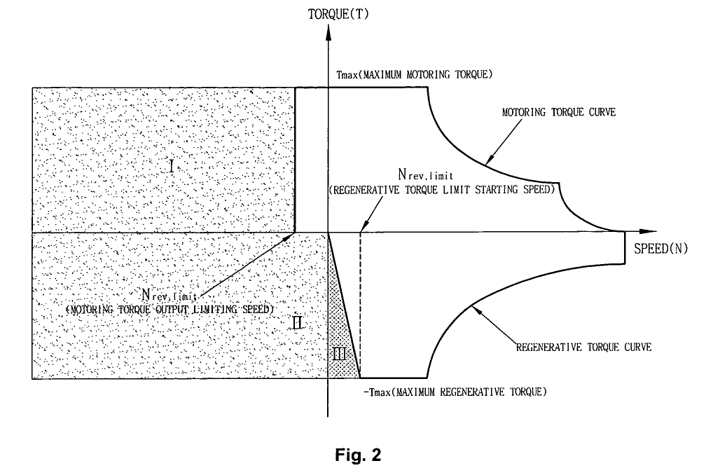

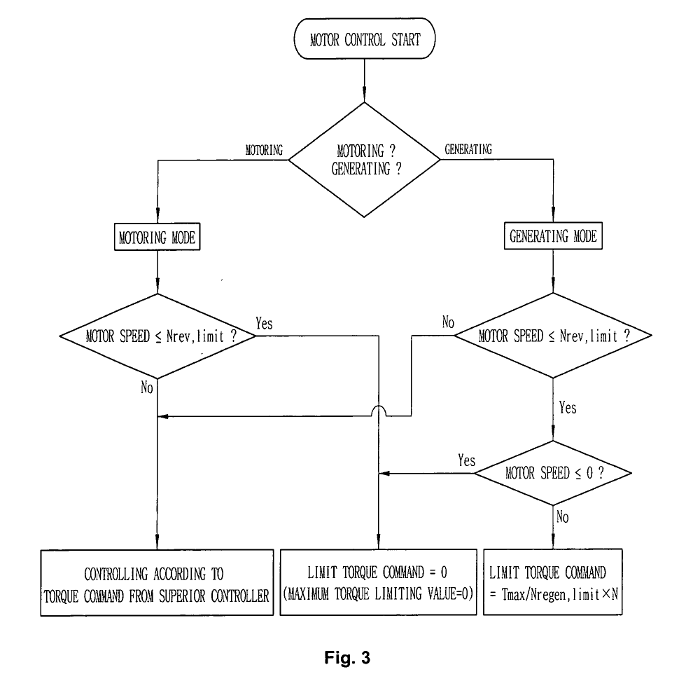

FIG. 2 is a diagram showing a torque-speed characteristic of motor torque control according to the present invention, and FIG. 3 is a flowchart illustrating a method for controlling motor torque according to the present invention.

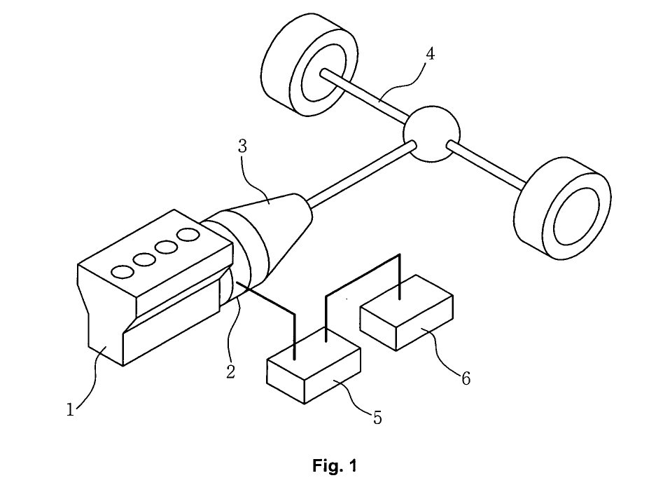

The configuration of a hybrid system to which the present invention is applied is the same as the conventional configuration shown in FIG. 1, in which a motor controller 5 controls the motor operation according to a torque command.

In general, the motor controller 5 controls the motor operation by receiving a torque command from a vehicle controller that is a superior controller; however, in the present invention, the motor controller limits motor torque output that can cause a reverse rotation of the engine even when torque and speed commands that may cause the reverse rotation of the engine are received from the vehicle controller.

In FIG. 2, section I is a reverse rotation region where the output of a motoring torque is limited, section II is a reverse rotation regenerative region where the output of a regenerative (generating) torque is limited, and section III is a forward rotation regenerative region where the motor torque limiting logic is performed in consideration of a regenerative torque limit starting speed (a parameter associated with an engine idling speed) and a current motor speed.

To achieve the object of the present invention, it is necessary to limit the motor torque output that can cause a reverse rotation of the engine and, thus, in second and third quarters of FIG. 2 where the actual speed of the motor is negative (−), the output of a motor torque should be limited.

However, since the reverse rotation of the engine may occur for a short period of time during start-up of the engine, when the motor is reversely rotated at a low speed in the second quarter of FIG. 2, the output of motor torque should be available.

Moreover, since the negative (−) torque may cause a reverse rotation of the motor during generation, the motor torque should become zero (0) at a time point when the motor speed becomes zero, and the motor torque should always be limited to 0 in the third quarter of FIG. 2.

Furthermore, it is necessary to consider transitional dynamic characteristics of the engine while preventing the reverse rotation of the engine.

The motor torque limiting logic in accordance with the present invention will be described in more detail with reference to FIG. 2.

In the first quarter section that is the motoring region of the forward rotation as a positive (+) state, the motor controller controls the motor to output a motoring torque (refer to the motoring torque curve) according to a torque command transmitted from the superior controller.

In the second quarter section that is the reverse rotation region, the motor controller limits the output of motor torque even in the positive (+) torque state. However, as discussed above, in the region where a temporary reverse rotation of the engine occurs for a short period of time during start-up of the engine at a low speed higher than a predetermined motoring torque output limiting speed, the motor controller controls the motor to output a maximum motoring torque.

In the third quarter section that is the reverse rotation regenerative region where the torque is negative (−) during generation and the motor speed is less than 0, the output of a regenerative torque is limited.

In the fourth quarter section that is the forward rotation regenerative region, the motor torque limiting logic is performed in consideration of a regenerative torque limit starting speed (a parameter associated with an engine idling speed) and a current motor speed. However, the regenerative torque limit process should be performed when the motor speed does not exceed the regenerative torque limit starting speed predetermined according to the engine idling speed. In a region where the motor speed exceeds the regenerative torque limit starting speed, the motor controller controls the motor to output the regenerative torque according to a torque command transmitted from the superior controller.

The motoring torque output limiting speed (N_{rev,limit}) can be defined as the following Formula 1:

$${N}_{rev , limit} = \frac{{ω}_{rev , limit} \times 60}{2 π} \\ {ω}_{rev , limit} = \frac{π}{{n}_{cylinder} \times dt} ( rad \text{/} s ) . \qquad [ Formula 1 ]$$

Accordingly, the motoring torque output limiting speed can be finally obtained from the following Formula 2:

$${N}_{rev , limit} = \frac{30}{{n}_{cylinder} \times dt} ( rpm ) \qquad [ Formula 2 ]$$

wherein n_{cylinder} represents the number of cylinders and dt represents a transitional time that is the time taken for a transitional reverse rotation of an engine during start-up.

A transitional reverse rotation occurs when crankshafts having various tilt angles are initiated during start-up of the engine. F or example, in a 4-cylinder engine, a movement of maximum ⅛ occurs (45 degrees) and, thus, assuming that the transitional time is 100 ms, the motoring torque output limiting speed becomes a rotational speed of about 75 rpm [in Formula 2, 30/(4×0.1)=75 rpm].

Next, the regenerative torque limit starting speed (N_{regen,limit}), as discussed above, may be set from the engine idling speed of the vehicle. An engine stall occurs when an excessive generating torque (regenerative torque) is applied in a region below the engine idling speed. Accordingly, assuming that a permissive undershoot value of an idling speed control is 50%, the generating torque (regenerative torque) limit is performed at 350 rpm obtained by the following Formula 3 for defining the regenerative torque limit starting speed:

N_{regen,limit}=engine idling speed×permissive undershoot(rpm) [Formula 3]

Moreover, in section III of the fourth quarter section of FIG. 2 that is the forward rotation regenerative region (generating mode) where the motor speed does not exceed the regenerative torque limit starting speed, the torque command can be calculated by the following Formula 4:

Limit torque command=(−Tₘₐₓ/N_{regen,limit})×motor speed [Formula 4]

wherein Tₘₐₓ represents a maximum regenerative torque.

Like this, in section III that is the region below the regenerative torque limit starting speed, the motor controller performs the motor torque limiting logic of the present invention based on the torque limiting value calculated from the Formula 4.

For example, assuming that the regenerative torque limit starting speed (N_{regen,limit}) is 350 rpm, the output of motor torque is 0 at a motor speed of 0 rpm, −Tₘₐₓ/2 at a motor speed of 175 rpm, and −Tₘₐₓ at a motor speed of 350 rpm.

Meanwhile, the motor torque limiting logic of the present invention shown in FIG. 2 can be expressed in the flowchart of FIG. 3, and the method for controlling a motor torque according to the present invention will be described with reference to FIG. 3 below.

First, the motor controller determines whether a current mode is a motoring mode or a generating mode and, if it is determined that the current mode is a motoring mode, compares a motor speed with a motoring torque output limiting speed. If the motor speed is greater than the motoring torque output limiting speed, the motor controller controls the motor to output torque according to a torque command transmitted from a superior controller. If the motor speed, however, does not exceed the motoring torque output limiting speed, the motor controller limits the output of motor torque using a torque command value of 0 according to the motor torque limiting logic of the present invention.

On the other hand, if the current mode is a generating mode, the motor controller compares the motor speed with a regenerative torque limit starting speed. If the motor speed does not exceed the regenerative torque limit starting speed and is greater than 0, the motor controller controls the output of motor output using a torque command obtained by Formula 4 according to the motor torque limiting logic of the present invention.

If the motor speed, however, does not exceed the regenerative torque limit starting speed and does not exceed 0, the torque command is 0 according to the motor torque limiting logic of the present invention, and thus the output of motor torque is limited.

Meanwhile, if the motor speed is greater than the regenerative torque limit starting speed, the motor controller controls the motor to output torque according to a torque command transmitted from the superior controller.

As described above, according to the present invention, the output of motor torque is limited in a region that can cause a reverse rotation of the engine, and the motor torque limiting logic is performed in consideration of the regenerative torque limit starting speed (a parameter in view of an engine idling speed) and the current motor speed even in the forward rotation regenerative region, thus effectively preventing the engine from being damaged due to the reverse rotation.

Especially, it is possible to prevent the engine from being damaged only with the motor torque limiting logic, i.e., a reverse rotation prevention logic, of the present invention without the use of hardware such as a transmission or clutch and without the use of any additional equipment.

Moreover, since the reverse rotation prevention logic is a logic in which dynamic characteristics of the engine and the motor are reflected, it is possible to minimize the possibility of a malfunction.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for limiting motor torque in a hybrid electric vehicle, the method comprising:
(a) determining whether a current mode is a motoring mode or a generating mode;
(b) comparing a current motor speed with a regenerative torque limit starting speed predetermined according to an engine idling speed of the vehicle, if the current mode is a generating mode; and
(c) limiting motor torque output using a torque command value calculated based on a maximum regenerative torque, the regenerative torque limit starting speed and the motor speed, if the motor speed exceeds 0 and does not exceed the regenerative torque limit starting speed in the generating mode.

2. The method of claim 1, wherein, in step (c), if the motor speed does not exceed 0, the motor torque output is limited using a torque command of 0.

3. The method of claim 1, wherein, in step (c), the torque command value for limiting the motor torque output is calculated by the following equation:
Limit torque command=(−Tₘₐₓ/N_{regen,limit})×motor speed
wherein Tₘₐₓ represents a maximum regenerative torque and N_{regen,limit} represents a regenerative torque limit starting speed.

4. The method of claim 1, wherein the regenerative torque limit starting speed is defined by multiplying the engine idling speed by a permissive undershoot value of an idling speed control.

5. The method of claim 1, further comprising:
(b′) comparing the current motor speed with a predetermined motoring torque output limiting speed, if the current mode is a motoring mode; and
(c) limiting the motor torque output using a torque command value of 0, if the motor speed does not exceed the motoring torque output limiting speed in the motoring mode.

6. The method of claim 5, wherein the motoring torque output limiting speed is defined based on the number of cylinders and a transitional time by the following equation:
$${N}_{rev , limit} = \frac{30}{{n}_{cylinder} \times dt} ( rpm )$$
wherein n_{cylinder} represents the number of cylinders and dt represents a transitional time that is the time taken for a transitional reverse rotation of the engine during start-up.
